(19) United States
(12) Patent Application Publication
(10) Pub. No.: US 2022/0237343 A1
(43) Pub. Date: Jul. 28, 2022

(54) TECHNIQUES FOR PROVIDING CONCRETE INSTANCES IN TRAFFIC SCENARIOS BY A TRANSFORMATION AS A CONSTRAINT SATISFACTION PROBLEM

(71) Applicant: Foretellix Ltd., Ramat Gan (IL)

(72) Inventors: Dmitry PIDAN, Netanya (IL); Cynthia Roxana DISENFELD, Kadima (IL); Yoav HOLLANDER, Kiriat Ono (IL)

(73) Assignee: Foretellix Ltd., Ramat Gan (IL)

(21) Appl. No.: 17/646,240

(22) Filed: Dec. 28, 2021

Related U.S. Application Data
(60) Provisional application No. 63/142,199, filed on Jan. 27, 2021.

(51) Int. Cl. G06F 30/20

(52) U.S. Cl. CPC G06F 30/20; G06F 2111/04

(57) ABSTRACT

A system and method for determining concrete instances in traffic scenarios are provided. The method includes receiving a scenario in a scenario description language, wherein the scenario includes at least one sub-scenario; identifying at least one variable for the scenario and the at least one sub-scenario based on parsing of at least one actor and the received scenario; identifying at least one constraint relation derived from the scenario and the at least a sub-scenario; generating, from the at least one variable and at least one constraint, a constraint satisfaction problem; processing the constraint satisfaction problem to generate sequences of states for the at least one variable that comply with the at least one constraint, wherein the sequence of states defines the behavior of the at least one actor with time values; and determining at least one solution that includes the sequences of states.

### CROSS-REFERENCE TO RELATED APPLICATIONS

This application claims the benefit of U.S. Provisional Application No. 63/142,199 filed on Jan. 27, 2021, the contents of which are hereby incorporated by reference.

### TECHNICAL FIELD

The present disclosure generally relates to systems and methods for description of traffic situations, also referred to as scenarios, and more specifically to the realization of scenarios.

### BACKGROUND

Advances in the field of autonomous vehicles are rapid. More and more, such vehicles are scheduled to hit the roads in the coming decade, and experimental vehicles are roaming the roads of many cities around the world. Like every sophisticated device that has been designed by humans, the autonomous vehicle enjoys the benefit of the ingenuity of mankind, as well as experiencing its shortcomings. The latter manifest themselves as undesired, unpredicted, or erroneous behavior of the autonomous vehicle, putting in danger the vehicle's occupants as well as other people, animals, and property around the vehicle.

In order to prevent such errors from occurring, vehicles are first tested prior to their release to the roads, and then, as they are deployed on the road, vehicles have additional precautions installed to ensure that no mishaps occur. In addition, a driver is assigned to each such vehicle with a capability to override the operation of the vehicle when a handling or response error occurs. This, of course, allows for capture of such sequences and updating of the control systems of the vehicle so that, in future, cases of such hazardous situations may be prevented. However, these solutions are error-prone, as they are heavily dependent on the capture of such errors as a result of an intervention by the operator, or cases where some sort of damage has occurred. Errors that lead to an undesirable result are not monitored efficiently or captured when they may prevent an undesirable outcome from occurring.

It has been identified that scenario-based testing can be used to monitor operations of autonomous vehicles based on predetermined expectations of proper operations. More particularly, scenario-based testing tests and verifies the practically endless number of scenarios that an autonomous vehicle may encounter on the road to develop a thoroughly tested drive-control system of autonomous vehicles. However, room for improvements still exist in that simulation of such scenarios often include a degree of freedom without a realization, also referred to as a concrete instance. That is, solutions of tested scenarios can still contain uncertainties that can be problematic for safe operation of autonomous vehicles.

It would therefore be advantageous to provide a solution that can find a proper realization of a scenario.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining concrete instances in traffic scenarios. The method comprises: receiving a scenario in a scenario description language, wherein the scenario describes a behavior of at least one actor, wherein the scenario includes at least one sub-scenario; identifying at least one variable for the scenario and the at least one sub-scenario based on parsing of the at least one actor and the received scenario; identifying at least one constraint relation derived from the scenario and the at least a sub-scenario; generating, from the at least one variable and at least one constraint, a constraint satisfaction problem; processing the constraint satisfaction problem to generate sequences of states for the at least one variable that comply with the at least one constraint, wherein the sequence of states defines the behavior of the at least one actor with time values; determining at least one solution that includes the sequences of states; and providing the at least one solution to a traffic simulator.

Certain embodiments disclosed herein also include a non-transitory computer readable medium having stored thereon causing a processor to execute a process, the process comprising: receiving a scenario in a scenario description language, wherein the scenario describes a behavior of at least one actor, wherein the scenario includes at least one sub-scenario; identifying at least one variable for the scenario and the at least one sub-scenario based on parsing of the at least one actor and the received scenario; identifying at least one constraint relation derived from the scenario and the at least a sub-scenario; generating, from the at least one variable and at least one constraint, a constraint satisfaction problem; processing the constraint satisfaction problem to generate sequences of states for the at least one variable that comply with the at least one constraint, wherein the sequence of states defines the behavior of the at least one actor with time values; determining at least one solution that includes the sequences of states; and providing the at least one solution to a traffic simulator.

Certain embodiments disclosed herein also include a system for determining concrete instances in traffic scenarios. The system comprises: a database containing therein a scenario in a scenario description language; a processor; and a memory, the memory containing instructions that, when executed by the processor, configure the system to: receive a scenario in a scenario description language from the database, wherein the scenario describes a behavior of at least one actor, wherein the scenario includes at least a sub-scenario; identify at least one variable for the scenario and the at least a sub-scenario based on parsing of the at least one actor and the received scenario; identify at least one constraint relation derived from the scenario and the at least a sub-scenario; generate from the at least one variable and at least one constraint a constraint satisfaction problem; process the constraint satisfaction problem to generate sequences of states for the at least one variable that comply with the at least one constraint, wherein the sequence of states defines the behavior of the at least one actor with time values; determine at least one solution that includes the sequences of states; and provide the at least one solution to a traffic simulator.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic description of a first scenario and a second scenario operating under the serial operator according to an embodiment.

FIG. 2 is a schematic description of different variations of spanning of a mix operator over a timeline according to an embodiment.

FIG. 3 is a schematic diagram of a conversion system for converting of a description of a scenario into a constraint satisfaction problem according to an embodiment.

FIG. 4 is a flowchart illustrating a method for converting a description of a scenario into a constraint satisfaction problem according to an embodiment.

FIG. 5 is a flowchart illustrating a method for converting a scenario and sub-scenarios to respective variables and constraints according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for providing a plurality of concrete instances of objects for the execution of a simulation based on a scenario described in a high-level scenario description language. Such scenario is applicable, for example, for an autonomous vehicle within traffic. Accordingly, the concrete instance has to satisfy: all constraints defined in the high-level described scenario; all modifiers of the scenario; and, all operators defining the timing relationships between the scenarios. According to an embodiment this is performed by representing the scenarios as a constraint satisfaction problem. Autonomous vehicles may include, but are not limited to the like of, cars, drones, and the like.

The purpose of constraint solving is to find efficient and practical solutions for constraint satisfaction problems. Constraint satisfaction problem (CSP) is a task of finding the values for a set of variables such that dependencies (constraints) between the variables are preserved. Variables are usually defined by the domain from which they can take their values (integer, range, real, string). Constraints are defined as Boolean expressions over those variables. For example, a dependency “x is greater than the sum of y and z” is defined by a Boolean inequality “x>z+y”.

Constraint solvers usually expose a set of application programing interface (API) functions that is rich enough to express any constraint satisfaction problem supported by that solver. Most also expose additional API functions to allow easy writing of the problem, and optimization of the solving process. The minimal API required for expressing the problems should contain: a) Boolean constants; b) Boolean variables; and c) a minimal set of Boolean operations (conjunction, negation). Typically, other components such as, but not limited to, integer and floating-point variables and constants, arithmetic operations (addition, subtraction, multiplication, division, modulo), additional Boolean operations (disjunction, implication), and comparison operations (equality, inequality, greater-than, lower-than), will also be made available. It should be appreciated that even when such components are missing from a constraint solver API, the problems may be expressed by the minimal set of operations that are required. For example, all arithmetic operations can be expressed using a minimal set of Boolean operations by an algorithm known as “bit-blasting”.

In order to be able to use standard constraint solving methods for finding a realization of a scenario by a CSP solver, the scenario should be represented as a constraint satisfaction problem. A constraint satisfaction problem (CSP) includes constants, variables, and constraints that define dependencies between those variables. According to an embodiment, a scenario includes the following components: field, constraints, actors, scenarios, and modifiers. The first two components can be used as-is in the resulting CSP, where fields are modeled as variables. Actors may include, but not limited to, vehicles, pedestrians, weather, road conditions, and more. Thus, the main goal of the modeling is to represent the actors, scenarios, and modifiers using variables and constraints over those variables. Such representation of the scenarios as CSPs including variable and constraints allow efficient and accurate realizations and eliminate abstract behaviors of involved actors. Accurate concrete instances are particularly advantageous in traffic scenarios of autonomous vehicles in that errors or inaccuracies can result detrimental effects on the safety of many. That is, accurate realization improves the operation accuracy and safety of autonomous vehicles for actual implementations.

A scenario has a temporal nature, meaning that its behavior is defined over some time window. Within this time window, each contained sub-scenario takes its own time slot, where the time slots of the sub-scenarios connect in the way defined by the operators of the description language of the scenario, for example, but not limited to, as described U.S. patent application Ser. No. 17/122,124 to Hollander et al, assigned to common assignee, the contents of which are hereby incorporated by reference (hereinafter the '124 patent application). Actors that participate in a scenario have a behavior over time. At each time point this behavior is described by a state, that is represented by a set of variables describing an actor's temporal properties (e.g., for cars those properties can be speed, position, acceleration, lights mode, etc.). For each actor, its state definition is a part of its scenario description. At each time point, the values of the actor's state fields describe the behavior of the actor at that time point. The behavior of the actor is represented over time as a sequence of state changes, where each state change, in addition to the properties defined by using the description language of an actor, contains a time label. This time label defines the time point at which the corresponding state becomes active (i.e., the actor is moving from the previous state to the current state). Given that an actor's state includes m variables, and its behavior is represented using n state changes, then at most m*n new variables are added to the constraint satisfaction problem. It should be noted that various optimizations for reducing the number of added variables are applicable without departing from the scope of the disclosed embodiments.

According to an embodiment, each scenario is represented by an interval [i . . . j] in the sequence of state changes for each actor participating in the scenario. The interval represents the start and the end of the scenario within a sequence of state changes of this particular actor. Since the time label of a state change uniquely defines when the state becomes active, synchronization between intervals automatically implies a synchronization between the start and the end time of the scenario. Given that the scenario is described in an appropriate description language, for each scenario invocation therein, two generative variables determining start and end of the interval of this scenario are defined. Then, the synchronization between different sub-scenarios is defined by operators working on those sub-scenarios and modeled by the constraints on interval bound variables, as further described herein.

The operator serial defines for all of its sub-scenarios that they are to be executed in turn, one after the other, i.e., when scenario ‘i’ ends, scenario i+1 starts, where ‘i’ is an integer greater than ‘1’. For example, S₁, . . . , Sₙ are scenarios connected by the serial operator. In this case, sᵢ, eᵢ are defined as the generative variables representing the start and the end of the interval corresponding to Sᵢ, respectively. Then, the serial connection between S₁ . . . Sₙ is modeled using the following constraints:

sᵢ₊₁=eᵢ ∀i ∈ 1 . . . n−1

FIG. 1 is an example schematic description 100 of a first scenario 130 and a second scenario 140 operating under the serial operator according to an embodiment. The scenarios s1 130 and s2 140 can be spanned over a timeline under the serial operator. It should be noted that the serialization solution of FIG. 1 is only one possible spanning out of many. Depending on the chosen number of states 120, and the context in which this example appears, constraint solver can find many different spanning. However, each of them will be consistent with the constraints that model the serial relation.

FIG. 1 therefore shows how scenarios under the serial operator can be spanned over the timeline. Each state-change 110, for example 110-1 through 110-8, is a pass from one state 120, for example state 120-2, to another state 120, for example state 120-3. In this particular example, there are eight state changes that includes the start 110-1 and the end 110-8 of the overall timeline. As an example, scenarios ms1, d1, and d2 that are connected by a serial relation thus satisfying the modeling constraint: d1 starts at state change 110-3, exactly where ms1 ends. Similarly, in an example, scenarios s1 and ms2 are connected by a serial relation and satisfy the modeling constraints.

Similarly, the parallel operator defines the following relation: all its sub-scenarios are fully synchronized in time, starting and ending at the same time point. That is, if S₁ . . . Sₙ are scenarios connected by the parallel operator, and sᵢ, eᵢ are the generative variables representing the start and the end of the interval corresponding to Sᵢ, respectively, then the parallel relation between S₁ . . . Sₙ is modeled using the following constraints:

sᵢ=sⱼ,eᵢ=eⱼ ∀i,j ∈ 1 . . . n

The mix operator defines the following relation between its sub-scenarios: given S₁ . . . Sₙ sub-scenarios of mix operator, each of the sub-scenarios S₂ . . . Sₙ has a non-empty overlap with S₁ over the timeline of S₁. Given sᵢ, eᵢ are the generative variables representing the start and the end of the interval corresponding to Sᵢ, relations of the mix operator are modeled using the following constraints:

sᵢ<eᵢ,s₁<eᵢ ∀i ∈ 2 . . . n

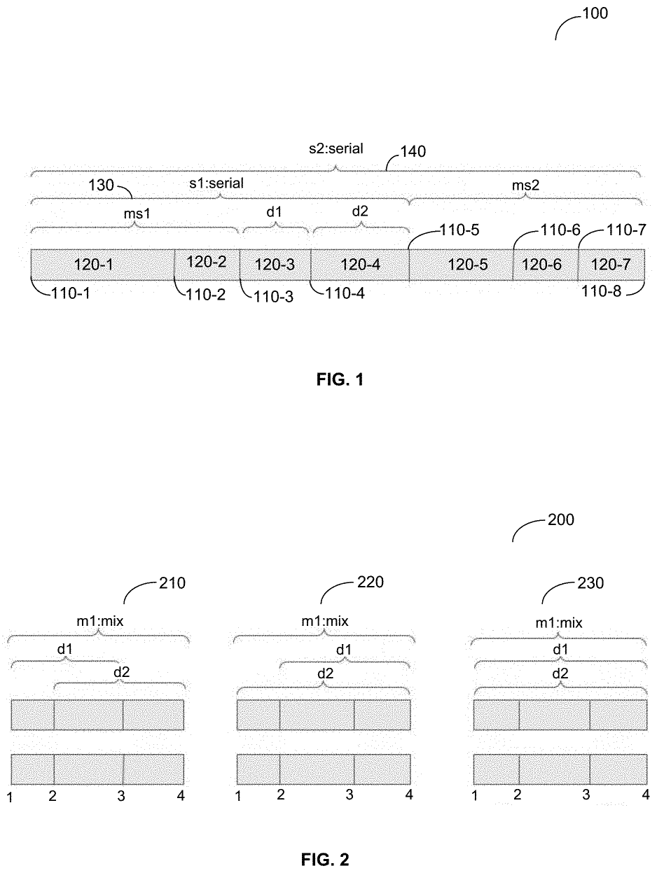

FIG. 2 is an example schematic description of different variations of spanning of a mix operator over a timeline according to an embodiment. In all shown variations, 210, 220, and 230, including sub-scenarios d1 and d2, the relation holds for constraints modeled by the mix operator. In the example 210, d1 starts at state change 1 and ends at state change 3, and d2 starts at state change 2 and ends at state change 4. Clearly, d1 starts before the end of d2 and ends after the start of d2. Another overlap of scenarios is shown in example 220, where d1 starts at state change 2 and ends at state change 4 and d2 starts at state change 1 and ends at state change 4. In example 230, a parallel relation between the sub-scenarios is demonstrated, which is natively a private case of the mix operator where scenario d2 overlaps the scenario d1 exactly.

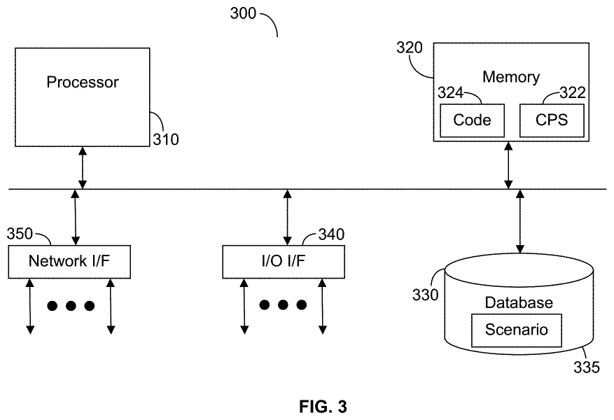

FIG. 3 shows an example schematic diagram of a conversion system 300 for converting a description of a scenario into a constraint satisfaction problem according to an embodiment. A processor 310, for example a central processing unit (CPU), is communicatively connected to a memory 320. The memory 320 may comprise both volatile memory, such as random-access memory (RAM), as well as non-volatile memory, such as read-only memory (ROM) and Flash memory. Parts of the memory, for example code area 324, contains therein code that may be executed by the processor 310, and as further explained herein. The memory 320 may further contain memory areas that provide for temporary and transient storage of data and/or code that is being operated on or by the processor 310. Furthermore, the memory 320, contains therein memory area 322 dedicated for at least code associated with a constraint problem solver (CPS) 322. The CPS code 322 when executed by the processor 310, provides one or more solutions to a set of variables and constraints provided thereto which satisfy the provided constraints, and as further explained herein. While CPS 322 is discussed herein other constraint solvers may be used without departing from the scope of the disclosed embodiments, including, but not limited to, Boolean satisfiability (SAT), satisfiability modulo theories (SMT) or theorem proving solvers, and the like.

A database 330 is communicatively connected to the processor 310 and contains therein one or more scenarios 335, and sub-scenarios thereof, that are to be used by the system 300 as described herein. The database 330 may be connected directly to the processor 310, in one embodiment. In another embodiment, a network interface 350 provides external network connectivity to the system 300 and the database 330 may be connected therethrough without departing from the scope of the invention. In one embodiment, the scenarios 335 are provided as video clips that are then processed on- or off-line to be described in a description language of scenarios as discussed herein. In an embodiment an input/output interface (I/O I/F) 340 is communicatively connected to the processor 310 for the purpose of providing inputs, for example from a keyboard, mouse, touchpad, camera, and like input devices, as well as outputs, for example a display, loudspeaker, printer and like output devices.

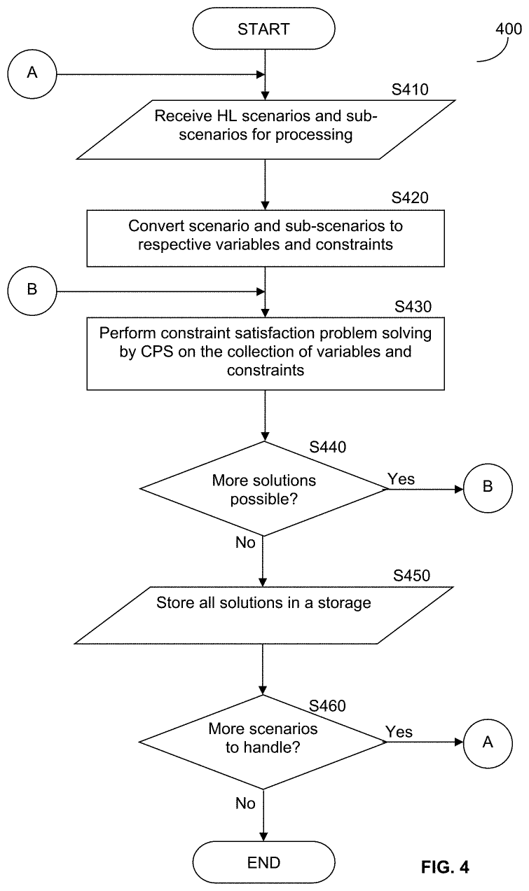

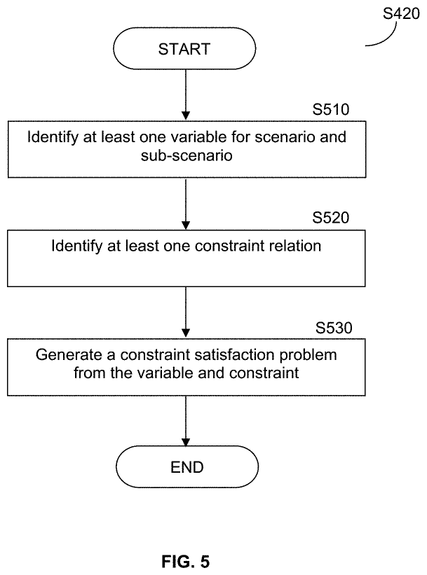

FIG. 4 is an example flowchart 400 illustrating a method for converting a description of a scenario into a constraint satisfaction problem according to an embodiment. The method is described with reference to components shown in FIG. 3.

At S410, a scenario and its sub-scenarios are received using, for example but not limited to, the system 300, FIG. 3. Such a scenario and its sub-scenarios may be provided from a database, for example database 330. Each of the scenarios and sub-scenarios thereof may be described in a scenario description language. In an example embodiment, the scenarios may be described in a high-level (HL) description language, for example but not limited to, the scenario language described in the '124 patent application.

At S420, the received scenario and sub-scenarios are converted into variables and constraints in a manner consistent with the requirements of the CPS 322. Furthermore, it is possible to add a constraint that represents a temporal relationship such as, but not limited to, serial, parallel, or mix. In an embodiment, a state of start variable and/or a state of end variable may be added. In one embodiment, S420 further comprises an optimization process where variables that do not impact a particular state are removed for that state. It should be appreciated that in S420 a vector is generated for each state (e.g., state 120-1, FIG. 1) that covers all its variables and respective constraints. The process of converting scenario and sub-scenarios to respective variables and constraints is discussed in greater detail with respect to FIG. 5 below.

At S430, a solution that satisfies the provided constraints is generated. The solution includes a plurality of states for the variables and that comply with the respective constraints. In an embodiment, an error may be generated if at least one solution to the constraint satisfaction problem is not found. In an embodiment, S430 is performed by the CPS 322. In another embodiment, a constraint satisfaction problem solver engine (not shown) that is adapted to process the constraint satisfaction problem may be used for increased efficiency and speed.

At S440, it is checked whether additional solutions are possible, or otherwise desired, and if so, execution continues with S430; otherwise, execution continues with S450. It should be noted that the CPS 322 provides all possible solutions that meet the constraints.

At S450, the one or more solutions are stored in memory 320 or other storage such as database 330.

At S460, it is checked whether additional scenarios are to be handled and if so, execution continues with S410; otherwise, execution terminates. According to an embodiment, the cases that satisfy the constraints are fed into a simulator for execution. In an embodiment, the cases (or solutions) may be provided to a traffic simulator. It should be appreciated that, in an embodiment, each state may include a copy of all variables present in the scenario description language code. Furthermore, in an embodiment, the states and their included variables are optimized such that only variables pertaining to that state are copied thereto. In an embodiment, the scenario may pertain to the like of a traffic condition or a traffic element.

FIG. 5 is an example flowchart S420 illustrating a method for converting a scenario and sub-scenarios to respective variables and constraints according to an embodiment.

At S510, at least one variable is identified for the scenario and sub-scenarios. The at least one variable may be identified by parsing the actors and scenarios which may further, be represented as an abstract syntax tree. In an embodiment, the at least one variable may be defined under each of the relevant actors.

At S520, at least one constraint relation is identified. The at least one constraint relation is derived from scenario and sub-scenarios.

At S530, a constraint satisfaction problem is generated from the identified at least one variable and at least one constraint relation.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining concrete instances in traffic scenarios, comprising:
receiving a scenario in a scenario description language, wherein the scenario describes a behavior of at least one actor, wherein the scenario includes at least one sub-scenario;
identifying at least one variable for the scenario and the at least one sub-scenario based on parsing of the at least one actor and the received scenario;
identifying at least one constraint relation derived from the scenario and the at least a sub-scenario;
generating, from the at least one variable and at least one constraint, a constraint satisfaction problem;
processing the constraint satisfaction problem to generate sequences of states for the at least one variable that comply with the at least one constraint, wherein the sequence of states defines the behavior of the at least one actor with time values;
determining at least one solution that includes the sequences of states; and
providing the at least one solution to a traffic simulator.

2. The method of claim 1, further comprising:
storing the at least one solution in a memory; and
generating an error message when the at least one solution is not determined, wherein an attempt to determine the solution is performed by a constraint satisfaction problem solver.

3. The method of claim 1, further comprising:
adding a start variable to the at least one variable.

4. The method of claim 1, further comprising:
adding an end variable to the at least one variable.

5. The method of claim 1, further comprising:
adding the at least one constraint representing a temporal relation.

6. The method of claim 5, wherein the temporal relation is at least one of: serial, parallel, and mix.

7. The method of claim 1, wherein each state of the sequences of states includes a copy of the at least one variable.

8. The method of claim 7, further comprising:
optimizing each state of the sequence of states to include only variables pertaining thereto.

9. The method of claim 1, wherein the scenario pertains to at least one of: a traffic condition and a traffic element.

10. The method of claim 9, wherein the traffic element is an autonomous vehicle.

11. The method of claim 1, wherein processing the constraint satisfaction problem uses any of: a designated constraint satisfaction problem solver, a Boolean satisfiability (SAT), a satisfiability modulo theories (SMT), and a theorem proving solver.

12. A non-transitory computer readable medium having stored thereon instructions for causing a processor to execute a process, the process comprising:
receiving a scenario in a scenario description language, wherein the scenario describes a behavior of at least one actor, wherein the scenario includes at least one sub-scenario;
identifying at least one variable for the scenario and the at least one sub-scenario based on parsing of the at least one actor and the received scenario;
identifying at least one constraint relation derived from the scenario and the at least a sub-scenario;
generating, from the at least one variable and at least one constraint, a constraint satisfaction problem;
processing the constraint satisfaction problem to generate sequences of states for the at least one variable that comply with the at least one constraint, wherein the sequence of states defines the behavior of the at least one actor with time values;
determining at least one solution that includes the sequences of states; and
providing the at least one solution to a traffic simulator.

13. A system for determining concrete instances in traffic scenarios, comprising:
a database containing therein a scenario in a scenario description language;
a processor; and
a memory, the memory containing instructions that, when executed by the processor, configure the system to:
receive a scenario in a scenario description language from the database, wherein the scenario describes a behavior of at least one actor, wherein the scenario includes at least a sub-scenario;
identify at least one variable for the scenario and the at least a sub-scenario based on parsing of the at least one actor and the received scenario;
identify at least one constraint relation derived from the scenario and the at least a sub-scenario;
generate from the at least one variable and at least one constraint a constraint satisfaction problem;
process the constraint satisfaction problem to generate sequences of states for the at least one variable that comply with the at least one constraint, wherein the sequence of states defines the behavior of the at least one actor with time values;
determine at least one solution that includes the sequences of states; and
provide the at least one solution to a traffic simulator.

14. The system of claim 13, wherein the system is further configured to:
store the at least one solution in a memory; and
generate an error message when the at least one solution is not determined by a constraint satisfaction solver.

15. The system of claim 13, wherein the system is further configured to: add a start variable to at least one variable.

16. The system of claim 13, wherein the system is further configured to: add an end variable to at least one variable.

17. The system of claim 13, wherein the system is further configured to: add at least one constraint representing a temporal relation.

18. The system of claim 17, wherein the temporal relation is at least one of: serial, parallel, and mix.

19. The system of claim 13, wherein each state of the sequence of states includes a copy of all variables.

20. The system of claim 19, wherein the system is further configured to: optimize each state of the sequence of states to include only variables pertaining thereto.

21. The system of claim 13, wherein the scenario pertains to at least one of: a traffic condition and a traffic element.

22. The system of claim 21, wherein the traffic element is an autonomous vehicle.

23. The system of claim 13, wherein the system is further configured to execute any one of: a designated constraint satisfaction problem solver, a Boolean satisfiability (SAT), a satisfiability modulo theories (SMT), and a theorem proving solver.
